(19) United States
(12) Patent Application Publication
(10) Pub. No.: US 2010/0078861 A1
(43) Pub. Date: Apr. 1, 2010

(54) METHOD AND DEVICE FOR BLOW MOLDING CONTAINERS

(76) Inventors: Thorsten Herklotz, Ahrensburg (DE); Werner Lesinski, Ahrensburg (DE); Michael Linke, Hamburg (DE); Michael Litzenberg, Geesthacht (DE); Rolf Baumgarte, Ahrenburg (DE); Frank Lewin, Tangstedt (DE)

Correspondence Address: FRIEDRICH KUEFFNER, 317 MADISON AVENUE, SUITE 910, NEW YORK, NY, 10017, US

(21) Appl. No.: 12/449,597

(22) PCT Filed: Feb. 8, 2008
(86) PCT No.: PCT/DE2008/000263

§ 371 Date: Nov. 16, 2009

(30) Foreign Application Priority Data
Feb. 15, 2007 (DE) 10 2007 006 023.0

(51) Int. Cl. B29C 49/12; B29C 49/78

(52) U.S. Cl. 264/532; 425/149; 425/150

(57) ABSTRACT

The invention relates to a method and a device for blow moulding containers. According to the invention, a preform consisting of a thermoplastic material is drawn out by a drawing bar after thermal conditioning inside a blow mould and is shaped into the container by a blowing pressure. The default positioning for the drawing bar is effected by an electromechanical drawing bar drive. A mechanical coupling device translates the rotational movement of a motor shaft of a servo motor into a lifting movement of the drawing bar.

The invention concerns a method for blow molding containers, in which a preform made of a thermoplastic material is subjected to thermal conditioning inside a blow mold and is then stretched by a stretch rod and shaped into a container by the action of blowing pressure.

The invention also concerns a device for blow molding containers made of a thermoplastic material, which has at least one blowing station with a blow mold and is provided with a stretching device, which has a stretch rod for acting on a preform inserted in the blow mold and in which the stretch rod is coupled with a lift control mechanism for coordinating the movement of the stretch rod.

In container molding by the action of blowing pressure, preforms made of a thermoplastic material, for example, preforms made of PET (polyethylene terephthalate), are fed to different processing stations within a blow-molding machine. A blow-molding machine of this type typically has a heating system and a blowing system, in which the preform, which has first been brought to a desired temperature, is expanded by biaxial orientation to form a container. The expansion is effected by means of compressed air, which is fed into the preform to be expanded. DE-OS 43 40 291 explains the process-engineering sequence in this type of expansion of the preform. The aforementioned introduction of the pressurized gas comprises both the introduction of compressed gas into the developing container bubble and the introduction of compressed gas into the preform at the beginning of the blowing process.

The basic structure of a blowing station for container molding is described in DE-OS 42 12 583. Possible means of bringing the preform to the desired temperature are explained in DE-OS 23 52 926.

Various handling devices can be used to convey the preforms and the blow-molded containers within the blow-molding device. The use of transport mandrels, onto which the preforms are slipped, has proven especially effective. However, the preforms can also be handled with other supporting devices. Other available designs are grippers for handling the preforms and expanding mandrels, which can be inserted in the mouth region of the preform to support the preform.

The handling of containers with the use of transfer wheels is described, for example, in DE-OS 199 06 438 with the transfer wheel arranged between a blowing wheel and a delivery line.

The above-explained handling of the preforms occurs, for one thing, in so-called two-step processes, in which the preforms are first produced by injection molding and temporarily stored and then later conditioned with respect to their temperature and blown into containers. For another, the preforms can be handled in so-called one-step processes, in which the preforms are first produced by injection molding and allowed to solidify sufficiently and are then immediately suitably conditioned with respect to their temperature and then blow molded.

With respect to the blowing stations that are used, various embodiments are known. In the case of blowing stations that are arranged on rotating transport wheels, book-like opening of the mold supports is often encountered. However, it is also possible to use mold supports that can be moved relative to each other or that are supported in a different way. In stationary blowing stations, which are suitable especially for accommodating several cavities for container molding, plates arranged parallel to one another are typically used as mold supports.

Various principles can be used for coordinating the movement of the stretch rod. It is well known, for example, that the stretch rod can be positioned by the use of cam rollers, which are guided along cam tracks. Especially high precision and reproducibility of the stretching operation can be realized with cam control mechanisms of this type if the cam rollers are guided on two sides and in this way follow an exactly defined path. However, cam control mechanisms of this type have the disadvantage that it is necessary to use heavy and spatially large-sized cam tracks, which are generally made of steel. A changeover of the stretching system to carry out changed stretching movements leads to great expense.

In addition, cam control mechanisms are known in which the cam rollers are guided on only one side and are pressed against the one-sided guide track with the use of pneumatic cylinders. To be sure, this is a simplified and thus less expensive and lighter design. However, depending on the stretching forces that arise, the cam roller can lift up from the cam track against the loading pneumatic tension, thereby causing the stretching operation to abandon the predetermined process characteristics. This results in deteriorated quality of the blow-molded containers.

Very exact stretching systems can be provided with the use of electric linear motors. However, linear motors of the required power rating are still very expensive at present and also take up a great deal of space.

Pure pneumatic systems as well as hybrid systems, in which both pneumatic drives and linear motors are used, are also already known.

All of the previously known systems for coordinating the performance of a stretching operation thus have a series of advantages and disadvantages, but so far it has not been possible to achieve optimal fulfillment of the requirements placed on these systems with minimization of the disadvantages that remain.

Therefore, the objective of the present invention is to specify a method of the aforementioned type in such a way that an easily adaptable, inexpensive and at the same time light control system for the stretching system is made available.

In accordance with the invention, this objective is achieved by preselecting the positioning of the stretch rod with the use of an electromechanical stretch rod drive, in which a rotational motion of a motor shaft of a servomotor is transformed to a lifting motion of the stretch rod by a mechanical coupling device.

A further objective of the invention is to design a device of the aforementioned type in such a way that a stretch rod control system is made available that is compact and easily adaptable at the same time.

In accordance with the invention, this objective is achieved by connecting the stretch rod with an electromechanical stretch rod drive that has a servomotor and a mechanical coupling device for connecting the stretch rod to the servomotor.

The combination of the electromechanical stretch rod drive, the mechanical coupling device and the stretch rod provides a rigid stretching system, which avoids the flexibility that arises in pneumatic stretching systems. This makes it possible to guarantee extremely precise stretch rod positioning. In addition, the relatively low structural weight of the individual components provides low mechanical inertia and thus high actuation dynamics.

A compact design is promoted especially if the transformation of the rotational motion into the lifting motion is carried out with the use of a threaded rod, on which a coupling element with an internal thread is supported.

A further increase in compactness can be realized if the threaded rod is positioned in the direction of the longitudinal axis of the motor shaft.

Improvement with respect to process engineering can be realized if force-controlled stretching is carried out with the use of the servomotor and the threaded rod.

Another variation in the production of containers consists in carrying out force-controlled blowing with the use of the servomotor and the threaded rod.

To reduce the energy requirement, it is proposed that the servomotor be operated as a generator during the return stroke of the stretch rod.

To help achieve electrical optimization, it is useful for the servomotor to be acted upon by a control system located in its immediate vicinity.

To avoid a transmission and the resulting inertia, it is proposed that the threaded rod be operated at a speed of rotation identical to that of the motor shaft.

To avoid fouling of the stretch rod, it is proposed that the threaded rod be covered by a covering in the direction towards the stretch rod.

High data transfer rates can be realized if a control system of the servomotor is connected by a bus system with an external control system.

In a typical embodiment, the servomotor is conveyed in a revolving path by a blowing wheel.

A modular control concept is promoted if the servomotor is connected with a power supply located on the blowing wheel and with a control unit located on the blowing wheel.

Specific embodiments of the invention are schematically illustrated in the drawings.

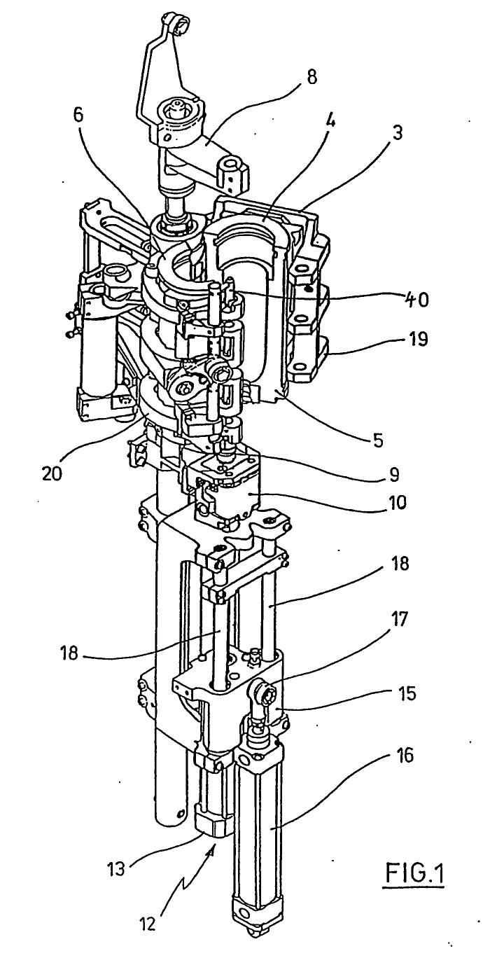

FIG. 1 shows a perspective view of a blowing station for producing containers from preforms.

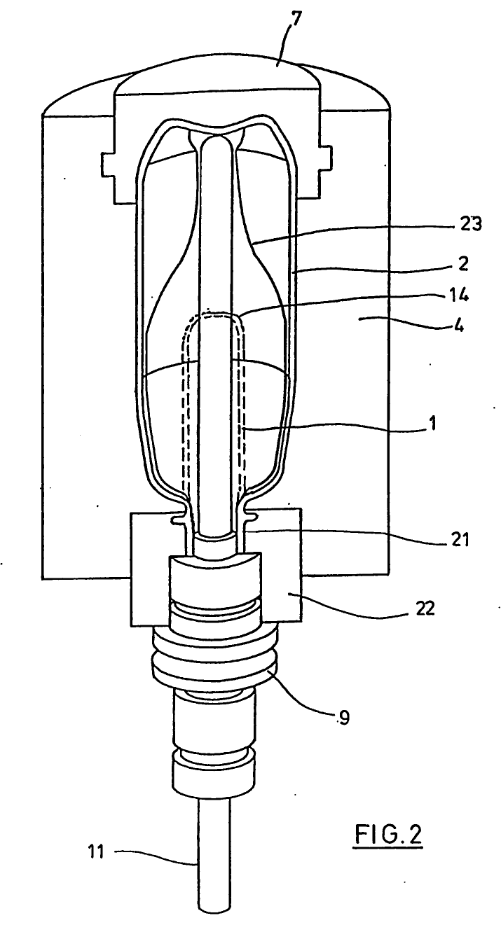

FIG. 2 shows a longitudinal section through a blow mold, in which a preform is stretched and expanded.

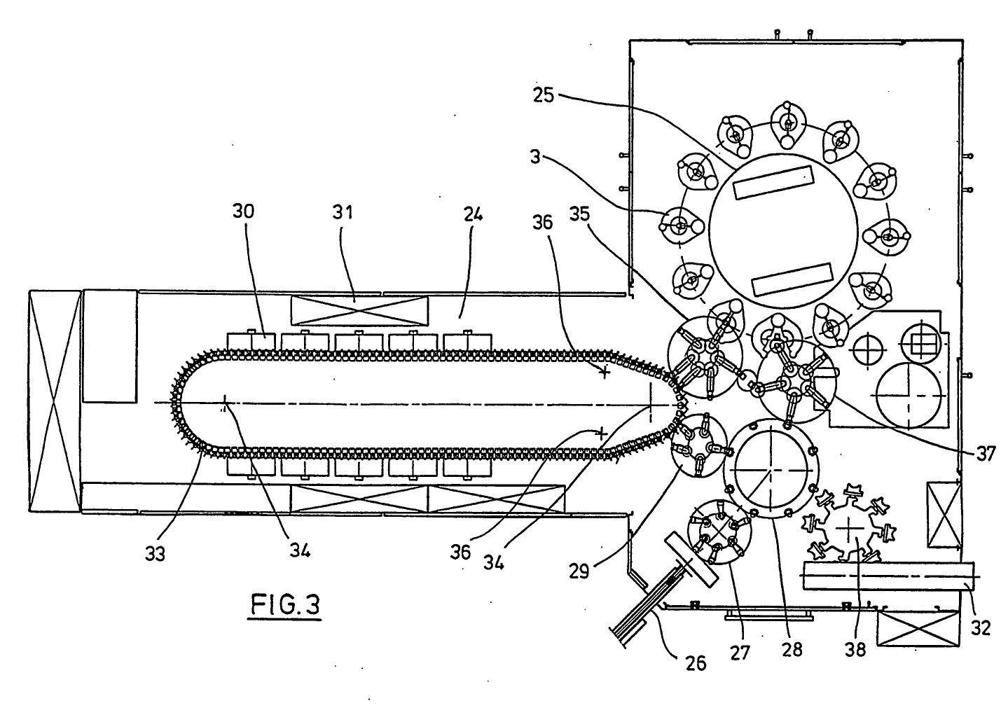

FIG. 3 is a drawing that illustrates a basic design of a device for blow molding containers.

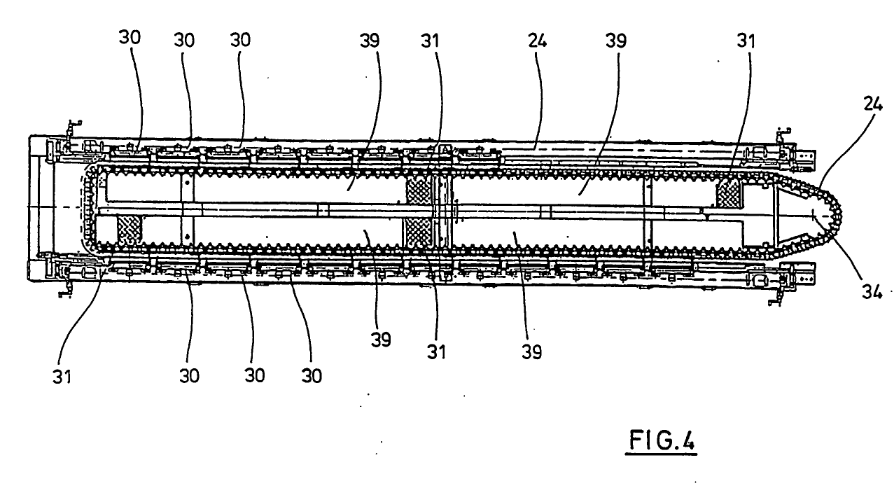

FIG. 4 shows a modified heating line with increased heating capacity.

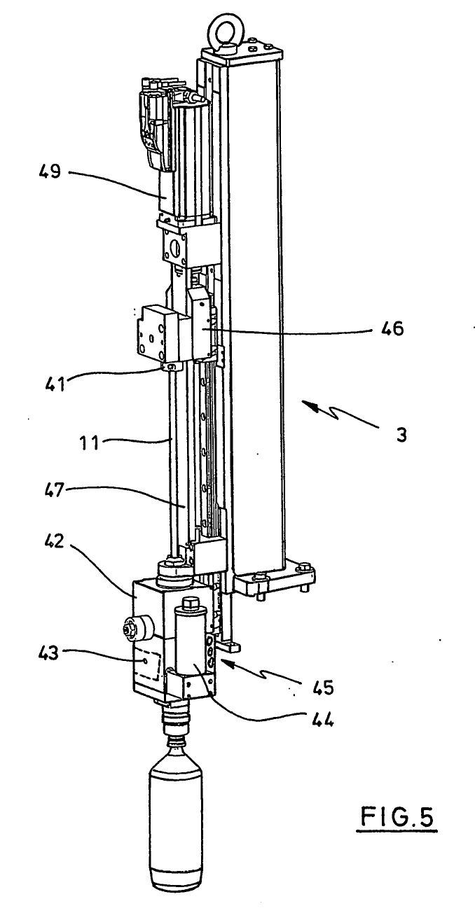

FIG. 5 shows a perspective side view of a blowing station, in which a stretch rod is positioned by a stretch rod carrier.

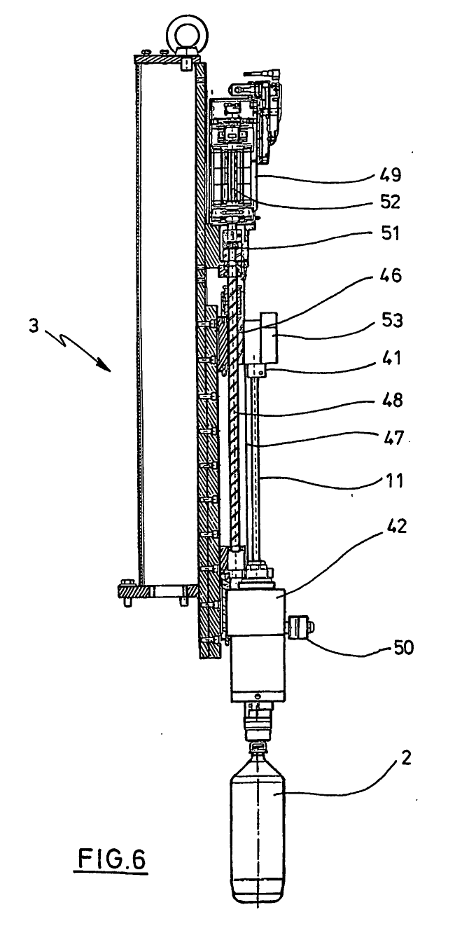

FIG. 6 shows a longitudinal section through the device shown in FIG. 5.

FIGS. 1 and 2 show the basic design of a device for shaping preforms 1 into containers 2.

The device for molding the container 2 consists essentially of a blowing station 3, which is provided with a blow mold 4, into which a preform 1 can be inserted. The preform 1 can be an injection-molded part made of polyethylene terephthalate. To allow a preform 1 to be inserted into the blow mold 4 and to allow the finished container 2 to be removed, the blow mold 4 consists of mold halves 5, 6 and a base part 7, which can be positioned by a lifting device 8. The preform 1 can be held in the area of the blowing station 3 by a transport mandrel 9, which, together with the preform 1, passes through a plurality of treatment stations within the device. However, it is also possible to insert the preform 1 directly into the blow mold 4, for example, with grippers or other handling devices.

To allow compressed air to be fed in, a connecting piston 10 is arranged below the transport mandrel 9. It supplies compressed air to the preform 1 and at the same time produces a seal relative to the transport mandrel 9. However, in a modified design, it is also basically possible to use stationary compressed air feed lines.

In this embodiment, the preform 1 is stretched by means of a stretch rod 11, which is positioned by a cylinder 12. In accordance with another embodiment, the stretch rod 11 is mechanically positioned by cam segments, which are acted upon by pickup rollers. The use of cam segments is advantageous especially when a large number of blowing stations 3 is arranged on a rotating blowing wheel.

In the embodiment illustrated in FIG. 1, the stretching system is designed in such a way that a tandem arrangement of two cylinders 12 is provided. Before the start of the actual stretching operation, the stretch rod 11 is first moved into the area of a base 14 of the preform 1 by a primary cylinder 13. During the stretching operation itself, the primary cylinder 13 with the stretch rod extended, together with a carriage 15 that carries the primary cylinder 13, is positioned by a secondary cylinder 16 or by a cam control mechanism. In particular, it is proposed that the secondary cylinder 16 be used in such a way under cam control that a current stretching position is predetermined by a guide roller 17, which slides along a cam track while the stretching operation is being carried out. The guide roller 17 is pressed against the guide track by the secondary cylinder 16. The carriage 15 slides along two guide elements 18.

After the mold halves 5, 6, which are arranged in the area of supports 19, 20, are closed, the supports 19, 20 are locked relative to each other by means of a locking mechanism 40.

To adapt to different shapes of a mouth section 21 of the preform 1, provision is made for the use of separate threaded inserts 22 in the area of the blow mold 4, as shown in FIG. 2.

In addition to the blow-molded container 2, FIG. 2 shows the preform 1, which is drawn with broken lines, and also shows schematically a container bubble 23 in the process of development.

FIG. 3 shows the basic design of a blow-molding machine, which has a heating line 24 and a rotating blowing wheel 25. Starting from a preform feeding device 26, the preforms 1 are conveyed to the area of the heating line 24 by transfer wheels 27, 28, 29. Radiant heaters 30 and fans 31 are arranged along the heating line 24 to bring the preforms 1 to the desired temperature. After sufficient heat treatment of the preforms 1, they are transferred to the blowing wheel 25, where the blowing stations 3 are located. The finished blow-molded containers 2 are fed to a delivery line 32 by additional transfer wheels.

To make it possible for a preform 1 to be formed into a container 2 in such a way that the container 2 has material properties that ensure a long shelf life of the foods, especially beverages, with which the container 2 is to be filled, specific process steps must be followed during the heating and orientation of the preforms 1. In addition, advantageous effects can be realized by following specific dimensioning specifications.

Various plastics can be used as the thermoplastic material, for example, PET, PEN, or PP.

The preform 1 is expanded during the orientation process by feeding compressed air into it. The operation of supplying compressed air is divided into a preblowing phase, in which gas, for example, compressed air, is supplied at a low pressure level, and a subsequent main blowing phase, in which gas is supplied at a higher pressure level. During the preblowing phase, compressed air with a pressure in the range of 10 bars to 25 bars is typically used, and during the main blowing phase, compressed air with a pressure in the range of 25 bars to 40 bars is supplied.

FIG. 3 also shows that in the illustrated embodiment, the heating line 24 consists of a large number of revolving transport elements 33, which are strung together like a chain and are moved along by guide wheels 34. In particular, it is proposed that an essentially rectangular basic contour be set up by the chain-like arrangement. In the illustrated embodiment, a single, relatively large-sized guide wheel 34 is used in the area of the extension of the heating line 24 facing the transfer wheel 29 and a feed wheel 35, and two relatively small-sized guide wheels 36 are used in the area of adjacent deflections. In principle, however, any other types of guides are also conceivable.

To allow the closest possible arrangement of the transfer wheel 29 and the feed wheel 35 relative to each other, the illustrated arrangement is found to be especially effective, since three guide wheels 34, 36 are positioned in the area of the corresponding extension of the heating line 24, namely, the smaller guide wheels 36 in the area of the transition to the linear stretches of the heating line 24 and the larger guide wheel 34 in the immediate area of transfer to the transfer wheel 29 and to the feed wheel 35. As an alternative to the use of chain-like transport elements 33, it is also possible, for example, to use a rotating heating wheel.

After the blow molding of the containers 2 has been completed, the containers 2 are carried out of the area of the blowing stations 3 by an extraction wheel 37 and conveyed to the delivery line 32 by the transfer wheel 28 and a delivery wheel 38.

In the modified heating line 24 illustrated in FIG. 4, a larger number of preforms 1 can be heated per unit time due to the larger number of radiant heaters 30. The fans 31 in this case feed cooling air into the area of cooling air ducts 39, which lie opposite the associated radiant heaters 30 and deliver the cooling air through discharge ports. A direction of flow of the cooling air essentially transverse to the direction of conveyance of the preforms 1 is realized by the arrangement of the discharge directions. In the area of surfaces opposite the radiant heaters 30, the cooling air ducts 39 can provide reflectors for the thermal radiation. It is also possible to realize cooling of the radiant heaters 30 by the delivered cooling air.

FIG. 5 shows a modified front perspective view of the blowing station 3 compared to the view shown in FIG. 1. In particular, this view shows that the stretch rod 11 is supported by a stretch rod carrier 41.

FIG. 5 also shows the arrangement of a pneumatic block 46 [sic]* for supplying blowing pressure to the blowing station 3. The pneumatic block 42 is equipped with high-pressure valves 43, which can be connected by connections 44 to one or more pressure supply sources. After the containers 2 have been blow molded, blowing air to be discharged to the environment is first fed to a muffler 45 via the pneumatic block 42.

The manner in which the blowing operation is typically carried out can be illustrated most simply with reference to FIG. 2. After the preform 1 has been inserted in the blow mold 4 and the blowing station 3 has been locked, the stretch rod 11 is first moved into the preform 1 with simultaneous assistance from blowing pressure in such a way that the preform 1 is not radially shrunk onto the stretch rod 11 by the axial stretching.

After the stretching operation has been completely carried out, as illustrated in FIG. 2, the container bubble 23 is completely expanded into the final contour of the container 2, and the maximum internal pressure is maintained until the container 2 has cooled to the point that it has sufficient dimensional stability. After dimensional stability has been achieved, the supply of blowing pressure is shut off, and the stretch rod 11 is pulled back out of the blow mold 4 and thus out of the blow-molded container 2.

FIG. 5 also illustrates that the stretch rod carrier 41 is connected with a coupling element 46, which is guided along at least part of its length behind a cover 47. The coupling element 46 can be positioned by a servomotor 49 with the use of a threaded rod 48, which is not shown in FIG. 5. The arrangement of the threaded rod 48 is explained in greater detail below with reference to FIG. 6.

FIG. 6 shows a longitudinal section through the device according to FIG. 5. A cam roller 50 is seen on the side of the pneumatic block 42. It serves the purpose of mechanical positioning of the pneumatic block 42. In particular, the cam roller 50 allows predetermination of the raising or lowering of the pneumatic block 42 relative to the container 2 or the preform 1.

In the illustrated embodiment, the coupling element 46 is realized as a threaded bushing, which has an internal thread that engages an external thread of the threaded rod 48. The coupling element 46 has connecting flanks that extend laterally along part of the cover 47 and in this way is connected with the stretch rod carrier 41. The cover 47 shields the stretch rod 11 from the threaded rod 48 to prevent fouling of the stretch rod 11, for example, by particles of grease or oil coming off the threaded rod 48.

The threaded rod 48 is connected by a coupling 51 with a motor shaft 52 of the servomotor 49. In the illustrated embodiment, the motor shaft 52 and the threaded rod 48 extend along a common longitudinal axis, so that the threaded rod 48 is positioned as an extension of the motor shaft 52. This helps to realize especially a gearless connection of the motor shaft 52 with the threaded rod 48.

A pneumatic valve 53 is installed on the outside on the stretch rod carrier 41 in order, when necessary, to convey a gaseous medium through the stretch rod 11 in the direction of the preform 1 or the container 2 or to carry it away in the opposite direction. In this regard, the gaseous medium can be, for example, blowing air or cooling air.

The coupling of the servomotor 49 with the stretch rod 11 via the threaded rod 48, the coupling element 46 and the stretch rod carrier 41 produces a system that is rigid with respect to external stresses and yet highly dynamic.

Measurement of the motor current of the servomotor 49 provides a simple means of deducing a current stretching force. In particular, this makes it possible to carry out a stretching operation not only as a function of a predetermined positioning profile but also as a function of a predetermined force profile. In this regard, it is possible, for example, to generate a constant stretching force along predetermined segments of the stretching distance or to generate a stretching force that varies in a predetermined way. It is also possible for the supply of blowing pressure to be controlled in a suitable way as a function of the stretching force determined by measurement of the motor current, since the actually occurring stretching forces are an indicator for the optimal supply of blowing pressure.

In accordance with another variant of the invention, it is possible, during a return stroke of the stretch rod 11 assisted by the internal pressure of the container 2, to operate the servomotor 49 as a generator and in this way to realize energy recovery. This makes it possible to reduce the electric operating power for the large number of servomotors 49 that are being used.

In accordance with another embodiment of the invention, in the case of an arrangement of the blowing station 3 on a rotating blowing wheel 25, it is proposed that a central power supply for the servomotors 49 be located on the blowing wheel 25. It is also possible for a control unit used for the operation of the servomotors 49 to be positioned on the blowing wheel 25. In accordance with another preferred embodiment, each of the servomotors 49 is equipped with a control system situated immediately adjacent to the given servomotor 49.

External preselection of control values is carried out with the use of a bus system, which connects the control unit located on the blowing wheel 25 with a stationary main control unit. The power supply located on the blowing wheel 25 for the individual servomotors 49 can be connected with a stationary power source by a slip-ring coupling.

In accordance with a preferred embodiment, the threaded rod 48 is operated at the same speed of rotation as the motor shaft 52. In principle, however, it is also possible to use a transmission to couple these two components. In a departure from the specific embodiment illustrated here, the motor shaft 52 and the threaded rod 48 can also have their longitudinal axes arranged transversely or obliquely to each other if a necessary frictional connection is produced by suitable coupling elements.

The aforementioned control of the blowing operation as a function of state data of the stretching operation can also be carried out, for example, in such a way that the preblowing pressure and/or the main blowing pressure is switched on as a function of an actual positioning of the stretch rod 11. For this purpose, it is not necessary to measure the actual position of the stretch rod 11 itself, but rather the present position of the stretch rod 11 can be determined by evaluating measured data of an incremental transducer located in the vicinity of the servomotor 49. When a predetermined position of the stretch rod 11 has been reached, an associated blowing gas valve is switched.

In the specific embodiments explained above, a stretching system with a stretch rod 11, threaded rod 48 and servomotor 49 is assigned to each individual blowing station 3. In particular, when the blowing stations 3 equipped with the stretching system of the invention are installed on a blowing wheel 25, it is possible in a simple way to adapt the carrying out of the stretching operation automatically to varying production rates and thus to varying speeds of rotation of the blowing wheel 25. With respect to process engineering, it has been found to be unfavorable, when the speed of rotation of the blowing wheel 25 changes, also to carry out the stretching operation at different stretching speeds, since this would affect the material properties of the containers 2 that are produced. An effort is thus made, even at different speeds of rotation of the blowing wheel 25, to realize the stretching operation with predetermined stretching speeds or stretching forces. The use of the stretching system of the invention with a servomotor 49 and threaded rod 48 makes it possible, in a simple way, to realize a preselection of the stretching parameters that is independent of the speed of rotation of the blowing wheel 25. Even for predeterminable and varying output capacities of the machine, this makes it possible to guarantee high quality of the containers 2 that are produced.

In accordance with another embodiment, when the blow-molding machine is equipped with an operating unit, for example, a visual display unit, it is proposed that an operator preset stretching distance/time profiles, stretching force/time profiles, stretching force/stretching distance profiles or other profiles for stretching parameters and realize them with a high degree of accuracy with the use of the stretching system of the invention.

With respect to the servomotor 49, it is possible in accordance with one specific embodiment, to integrate an automatic controller that is being used directly in the motor. As an alternative to the aforementioned arrangement of the threaded rod 48 as an extension of the motor shaft 52 and to the aforementioned oblique or perpendicular arrangement of the servomotor 49 relative to the threaded rod 48 with the interconnection of a transmission or other coupling elements, it is also possible, for the purpose of obtaining a compact embodiment, to arrange the motor on the side next to the threaded rod 48 and to realize the necessary coupling of the servomotor 18 with the threaded rod 48 by means of a double angular gearing or other suitable coupling devices.

In accordance with a preferred embodiment of the invention, it is especially contemplated that the assembly comprising the coupling element 46 and the threaded rod 48 be realized as a ball screw spindle. In this connection, the coupling element 46 has an internal thread like a nut, which engages an external thread of the threaded rod 48. Direct contact of the flights of the internal thread of the coupling element 46 and the external thread of the threaded rod 48 with each other can be avoided by arranging balls in the thread region similar to a ball bearing. In this way, the internal thread and the external thread do not slide directly on each other and thus do not generate sliding friction, but rather a much lesser rolling friction is realized.

To help achieve a compact and inexpensive embodiment, the balls are preferably arranged in the area of the internal thread of the coupling element 46.

1. A method for blow molding containers, in which a preform made of a thermoplastic material is subjected to thermal conditioning inside a blow mold and is then stretched by a stretch rod and shaped into a container by the action of blowing pressure, wherein the positioning of the stretch rod (11) is preselected with the use of an electromechanical stretch rod drive, in which a rotational motion of a motor shaft (52) of a servomotor (49) is transformed to a lifting motion of the stretch rod (11) by a mechanical coupling device.

2. A method in accordance with claim 1, wherein the transformation of the rotational motion into the lifting motion is carried out with the use of a threaded rod (48), on which a coupling element (46) with an internal thread is supported.

3. A method in accordance with claim 1, wherein the threaded rod (48) is positioned in the direction of the longitudinal axis of the motor shaft (52).

4. A method in accordance with claim 1, wherein force-controlled stretching is carried out with the use of the servomotor (49) and the threaded rod (48).

5. A method in accordance with claim 1, wherein force-controlled blowing is carried out with the use of the servomotor (49) and the threaded rod (48).

6. A method in accordance with claim 1, wherein the servomotor (49) is operated as a generator during the return stroke of the stretch rod (11).

7. A method in accordance with claim 1, wherein the servomotor (49) is acted upon by a control system located in its immediate vicinity.

8. A method in accordance with claim 1, wherein the threaded rod (48) is operated at a speed of rotation identical to that of the motor shaft (52).

9. A method in accordance with claim 1, wherein the threaded rod (48) is covered by a covering in the direction towards the stretch rod (11).

10. A method in accordance with claim 1, wherein a control system of the servomotor (59) is connected by a bus system with an external control system.

11. A method in accordance with claim 1, wherein the servomotor (49) is conveyed in a revolving path by a blowing wheel (25).

12. A method in accordance with claim 1, wherein the servomotor (49) is connected with a power supply located on the blowing wheel (25) and with a control unit located on the blowing wheel (25).

13. A device for blow molding containers made of a thermoplastic material, which has at least one blowing station with a blow mold and is provided with a stretching device, which has a stretch rod for acting on a preform inserted in the blow mold and in which the stretch rod is coupled with a lift control mechanism for coordinating the movement of the stretch rod, wherein the stretch rod (11) is connected with an electromechanical stretch rod drive that has a servomotor (49) and a mechanical coupling device for connecting the stretch rod (11) to the servomotor (49).

14. A device in accordance with claim 13, wherein the coupling device comprises a threaded rod (48) and a coupling element (46) that has an internal thread with which it is supported on the threaded rod (48).

15. A device in accordance with claim 13, wherein the threaded rod (48) is arranged as an extension of the motor shaft (52) of the servomotor (49).

16. A device in accordance with claim 13, wherein the servomotor (49) is connected to a control system for carrying out force-controlled stretching.

17. A device in accordance with claim 13, wherein the servomotor (49) is connected to a control system for carrying out force-controlled blowing.

18. A device in accordance with claim 13, wherein the servomotor (49) is designed to operate as a generator on an intermittent basis.

19. A device in accordance with claim 13, wherein a control system of the servomotor (49) is located in the immediate vicinity of the servomotor (49).

20. A device in accordance with claim 13, wherein the motor shaft (52) is rigidly coupled with the threaded rod (48) by a coupling (51).

21. A device in accordance with claim 13, wherein a cover (47) extends between the threaded rod (48) and the stretch rod (11).

22. A device in accordance with claim 13, wherein the control system of the servomotor (49) is connected by a bus system with an external control system.

23. A device in accordance with claim 13, wherein both the blowing station (3) and the servomotor (49) are located on a blowing wheel (25).

24. A device in accordance with claim 13, wherein both a power supply for the servomotor (49) and a control unit for the servomotor (49) are located on the blowing wheel (25).

25. A device in accordance with claim 13, wherein the stretch rod (11) extends essentially parallel to the threaded rod (48).
